(19) United States
(12) Patent Application Publication
(10) Pub. No.: US 2022/0005382 A1
(43) Pub. Date: Jan. 6, 2022

(54) LABEL SHEET ASSEMBLY WITH PUNCTURE SURFACE FEATURES

(71) Applicant: CCL Label, Inc., Framingham, MA (US)

(72) Inventors: Laura Shurtliffe, Whitby (CA); Angelo Capobianco, Whitby (CA)

(21) Appl. No.: 17/234,975

(22) Filed: Apr. 20, 2021

Related U.S. Application Data
(60) Provisional application No. 63/047,357, filed on Jul. 2, 2020.

(51) Int. Cl. G09F 3/10; G09F 3/02

(52) U.S. Cl. CPC G09F 3/10; G09F 3/02; G09F 2003/0269; G09F 2003/0201; G09F 2003/0202

(57) ABSTRACT

A label sheet assembly is disclosed for improving the process of feeding label sheets through a printer. The label sheet includes a facestock layer and a liner sheet. The facestock layer includes an adhesive layer along a first side and include a label surface along a second side opposite the adhesive layer. The label sheet may include a puncture surface feature along a matrix portion of the facestock layer, wherein the puncture surface feature may include a plurality of puncture holes formed in a shape wherein each puncture hole that forms a slightly concave shape along one side and a slightly convex shape along the opposite side. The puncture surface features provides a zone of tactile sensitivity along the label sheet and are configured to reduce off-registration of printed indicia along the at least one label when processed through a printer device.

### CROSS-REFERENCES TO RELATED APPLICATIONS

This application claims priority to and the benefit of U.S. Provisional Patent application No. 63/047,357, titled “LABEL SHEET ASSEMBLY WITH PUNCTURE SURFACE FEATURES,” filed on Jul. 2, 2020. The present application is also related to U.S. patent application Ser. No. 15/813,693, titled “LABEL SHEET ASSEMBLY WITH SURFACE FEATURES,” filed on Nov. 17, 2017, which claims the benefit of U.S. Provisional Application No. 62/422,364, titled “LABEL SHEET FEED EDGE ASSEMBLY,” filed on Nov. 15, 2016, and U.S. Provisional Application No. 62/475,288, titled “LABEL SHEET ASSEMBLY WITH SURFACE FEATURES,” filed on Mar. 23, 2017 which are hereby incorporated by reference in their entirety.

### FIELD OF INVENTION

The present disclosure generally relates to a label sheet assembly and method of making a label sheet assembly that is configured to be processed through a printer to print indicia thereon. More particularly, the disclosure relates to a label sheet assembly with patterns of puncture surface features that is configured to improve printer processing.

### BACKGROUND

Labels and label sheets are well known, and various types have been proposed to meet the requirements of a wide variety of label applications. For example, labels are extensively used in retail businesses for communicating product information to customers. Labels generally include a facestock layer with an adhesive side and an exposed side. The exposed side includes a surface for receiving label indicia thereon and is opposite from the adhesive side. A liner sheet is operably attached to the adhesive side and is configured to allow a user to peel the label portion of the facestock from the liner sheet to be placed on a substrate. A plurality of cut lines may separate the facestock layer into a plurality of labels in various arrangements.

Many label sheets are configured to be fed through a printer to print ink on the surface of the labels. For example, U.S. Pat. No. 7,709,071 to Wong et al. discloses a particular type of label sheet assembly that is configured to be fed through a printer, and also allows a user to easily remove labels by hand. This patent is incorporated herein by reference in its entirety. These label sheet assemblies allow a user broad discretion as to the orientation of the label and the indicia to be printed thereon. However, problems arise when a user processes label sheets through a printer, such as an inkjet printer, desktop printer, or laser printer. Many printers are configured to receive a label sheet or other sheet and process it through at least one, but usually more than one, rotary mechanism during the printing process. These processes may cause portions of the label sheet assembly to become creased, manipulated or otherwise disengaged. This may cause ink to shift or labels to be moved relative the remaining facestock layer or liner sheet. This off-registration may be due, in part, to the level of friction between a leading edge of the label sheet and the receiving area of the printer device. Labels risk damage and indicia may not be accurately printed along the labels.

Therefore, there is a need for a label sheet assembly having a facestock and liner material that can be configured to reduce inconsistent processing through a printer. There is also a need for an improved method of feeding a label sheet through a printer to accurately apply ink or indicia thereon without unduly manipulating the orientation of the labels or label sheet assembly.

### SUMMARY

The present system leverages the advantages of a label sheet assembly with a plurality of puncture surface features arranged in a pattern. Provided are embodiments of a label sheet assembly that include a facestock layer having first and second sides, the facestock layer including at least one cut line that defines at least one label on the first side wherein the facestock layer is configured to receive indicia thereon. Additionally, a matrix portion, or portion not intended to receive indicia thereon, may be included in the facestock layer. An adhesive layer is provided along the second side and a liner sheet layer having top and bottom surfaces, the top surface attached to the adhesive layer along the facestock layer. At least one puncture surface feature is provided along a header portion or a footer portion of the label sheet assembly, wherein the at least one puncture surface feature may provide a zone of increased tactile sensitivity along the label sheet assembly. Further, the puncture surface feature may also provide a zone of increased friction thereon.

A first puncture surface feature may be applied along a header portion and may include a plurality of holes that extend through the facestock layer and the liner sheet layer in a desired pattern. A second puncture surface feature may be applied along a footer portion and may include a plurality of holes that extend through the facestock layer and the liner sheet layer. The at least one puncture surface feature may be configured in the form of a shape such as a triangle, octagon, square, arrow, star, rectangle, or any other shape. Also, the puncture surface feature may include a plurality of holes arranged in a pattern of letters or numbers. Further, the pattern of the puncture surface feature may be outlined with indicia along the header portion and the footer portion. Such indicia may include a border, pattern, color, image, or font that is arranged with the pattern of the plurality of puncture surface features. The puncture surface features may include a patterned solid color with contrasting indicia located along the header or footer portions.

Specific reference is made to the appended claims, drawings, and description below, all of which disclose elements of the disclosure. While specific embodiments are identified, it will be understood that elements from one described aspect may be combined with those from a separately identified aspect, as combinations of the described features can be exchanged and/or replaced with the other disclosed features herein. In the same manner, a person of ordinary skill will have the requisite understanding of common processes, components, and methods, and this description is intended to encompass and disclose such common aspects even if they are not expressly identified herein.

### BRIEF DESCRIPTION OF THE DRAWINGS

Operation of the disclosure may be better understood by reference to the following detailed description taken in connection with the following illustrations, wherein:

FIG. 1 is a cross sectional view of an embodiment of a label sheet assembly of the present disclosure;

FIG. 2 is a perspective view of an embodiment of a label sheet assembly of the present disclosure with a plurality of puncture surface features;

FIG. 3 is a perspective view of an embodiment of a label sheet assembly of the present disclosure with a plurality of puncture surface features;

FIG. 4 is a plan view of an embodiment of the label sheet assembly of the present disclosure with a plurality of puncture surface features;

FIG. 5 is a back view of an embodiment of the label sheet assembly of the present disclosure with a plurality of puncture surface features;

FIG. 6 is a plan view of an embodiment of the label sheet assembly of the present disclosure with a plurality of puncture surface features;

FIG. 7 is an enlarged perspective view of an embodiment of the label sheet assembly of FIG. 3;

FIG. 8 is an enlarged perspective view of another embodiment of the label sheet assembly in accordance with an embodiment of the present disclosure;

FIG. 9A is an enlarged cross-sectional schematic view of a portion of the label sheet assembly illustrating a puncture surface feature and a method of forming the puncture surface feature according to the present disclosure;

FIG. 9B is an enlarged cross-sectional schematic view of a portion of the label sheet assembly illustrating a puncture surface feature and a method of forming the puncture surface feature according to the present disclosure; and

FIG. 10 is a front view of an image of an embodiment of the label sheet assembly illustrating a plurality of patterns and a plurality of puncture surface features according to the present disclosure.

### DETAILED DESCRIPTION

Reference will now be made in detail to embodiments of the present disclosure, examples of which are illustrated in the accompanying drawings. It is to be understood that other embodiments may be utilized and structural and functional changes may be made without departing from the respective scope of the disclosure. Moreover, features of the various embodiments may be combined or altered without departing from the scope of the disclosure. As such, the following description is presented by way of illustration only and should not limit in any way the various alternatives and modifications that may be made to the illustrated embodiments and still be within the spirit and scope of the disclosure.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

A label sheet assembly 10 is disclosed and may be of any appropriate configuration and is not limited to that shown and described herein. It should similarly be understood that the sheet assembly 10 may be adapted to any appropriate size, including, without limitation, 8.5 inches by 11 inches, A4 size, legal size or any other size, including, without limitation smaller sizes. The sheet assembly 10 may be made of any appropriate materials and colors or indicia and this disclosure is not limited in this regard.

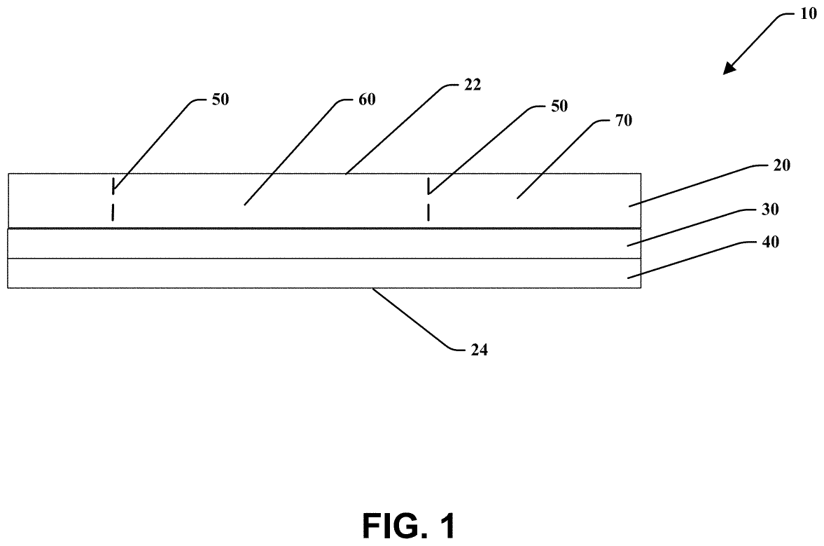

FIG. 1 is a cross sectional side view of the sheet assembly 10 that may include a facestock layer 20 that may be coated with a pressure sensitive adhesive layer 30. The sheet assembly 10 may also include a liner sheet 40 attached to the adhesive layer 30. The liner sheet 40 may include a release coating for supporting the adhesive layer 30. The liner sheet 40 may be made of any appropriate material, including, without limitation a calendared paper or polymer film. The facestock layer 20 may be of any appropriate material, including, without limitation a paper, plastic or polymer material such as a polyester material or other transparent, translucent or semi-translucent material. The facestock layer 20 may also be a laminate or a label or combination of both. The facestock layer may have a top surface 22 that is configured to receive indicia thereon.

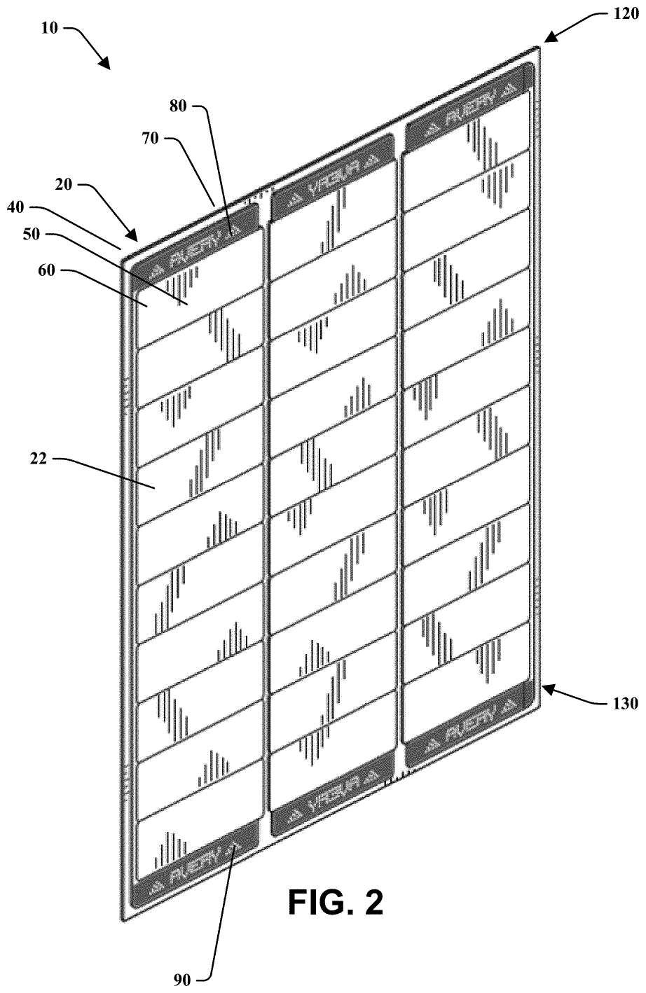

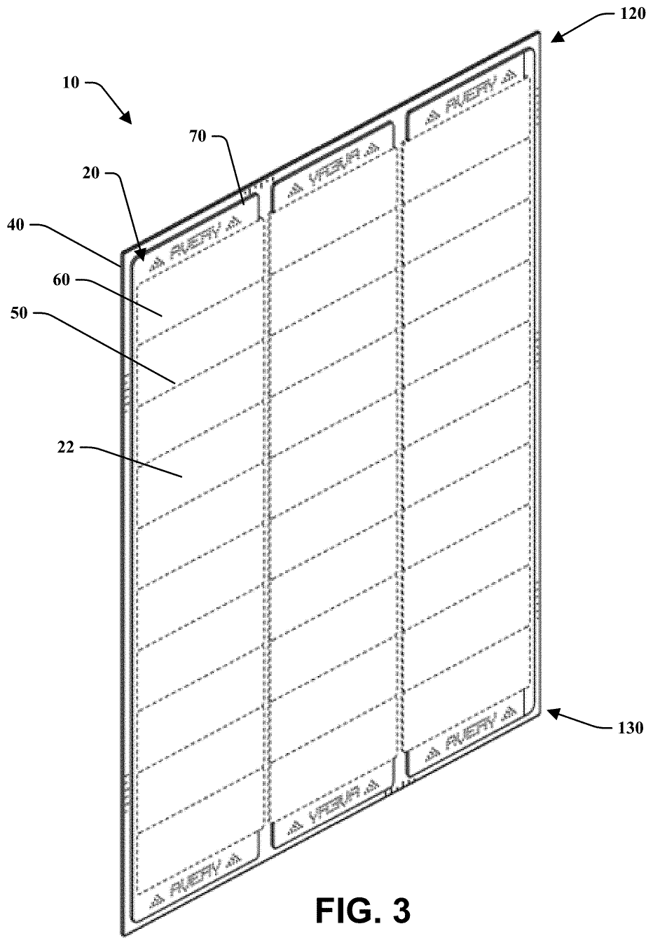

As illustrated by FIGS. 2 and 3, the top surface 22 of facestock layer 20 in embodiments of the sheet assembly 10 are shown in a perspective view. The sheet assembly 10 may include at least one cut line 50 that may extend through the facestock layer 20 to separate the sheet assembly into at least one label 60 and a matrix portion 70. In this embodiment, the facestock layer 20 includes thirty (30) labels 60 having a generally rectangular shape with rounded corners, wherein ten labels are aligned in each of three rows. However, this application is not limited as to the configuration, amount, or size of the labels 60. The present labels 60 are disclosed for the sake of brevity, but the teachings herein apply to any number of labels, in any number of columns, and any size and shape of labels.

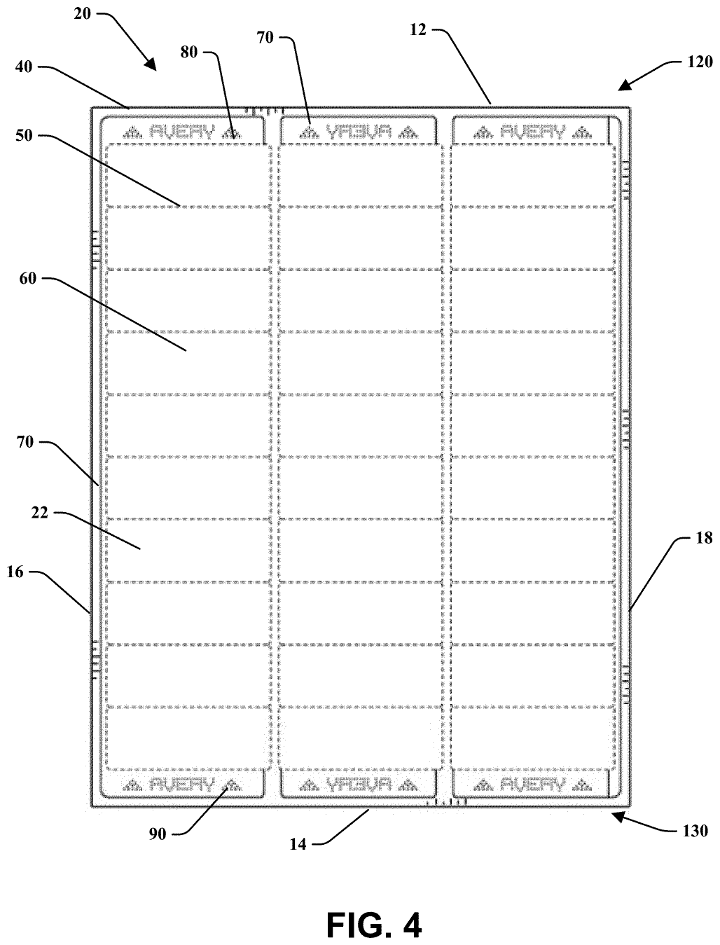

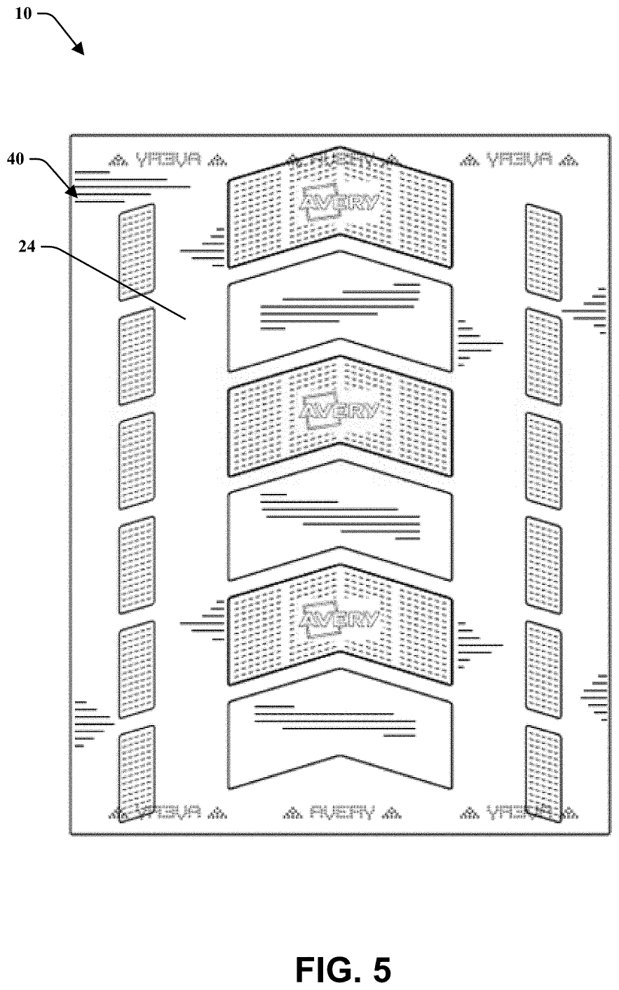

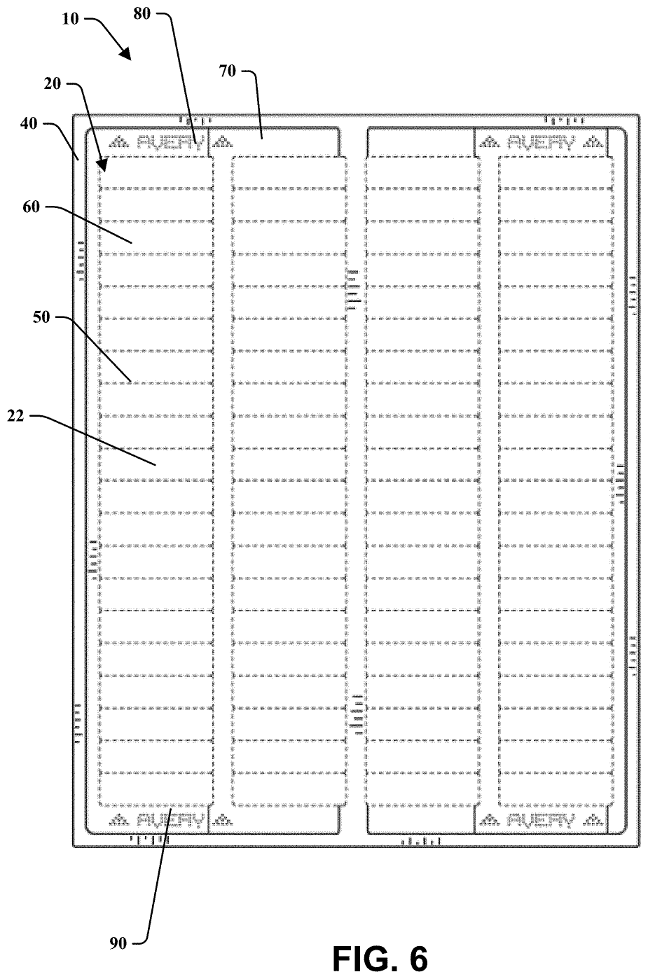

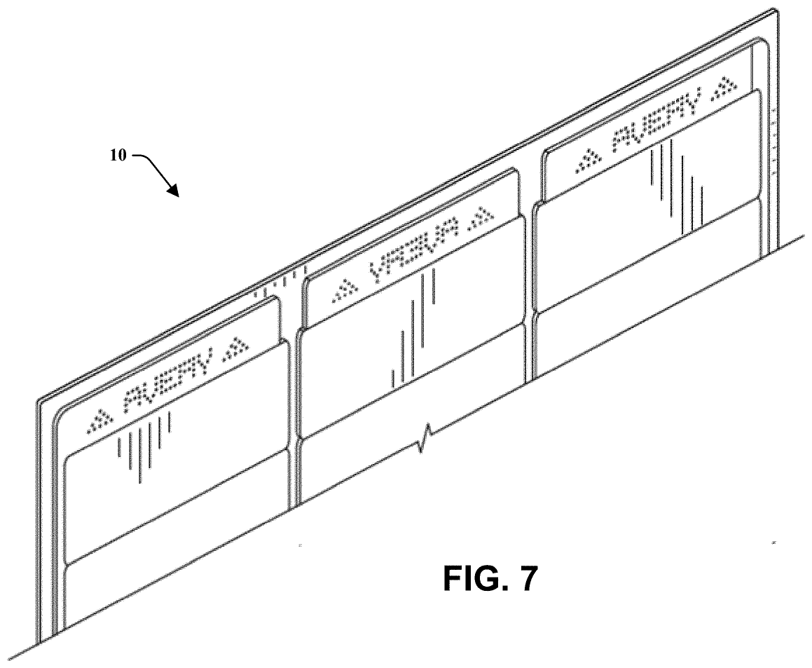

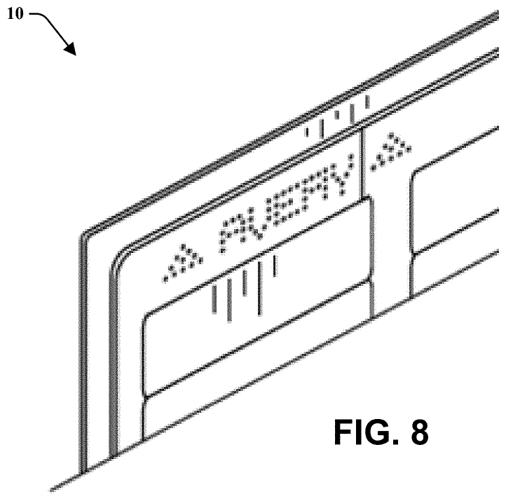

Turning to FIG. 4, the label sheet assembly 10 may include a first edge 12 and opposite second edge 14, along with a third edge 16 and opposite fourth edge 18. These edges 12, 14, 16, 18 may intersect to form a generally rectangular sheet assembly, wherein the label sheet assembly 10 may be configured to be fed into a conventional printer device or conventional scanner device (such as, by way of a non-limiting example, an ink jet and/or laser printer) from any edge.

The label sheet assembly 10 may include various surface features in different arrangements and be made from various materials, as disclosed in related U.S. patent application Ser. No. 15/813,693. In one embodiment, the surface feature is a plurality of first puncture surface features 80 that may be positioned along the matrix portion 70 of the facestock layer 20. The puncture surface features 80 may be placed along and adjacent to the first edge 12 between the third edge 16 and the fourth edge 18 as illustrated. This location may be referred to as the header portion 120. Further, there may be a plurality of puncture surface features 90 that may be positioned along the matrix portion 70 along an opposite side of the label sheet assembly 10 as the first plurality of puncture surface features 80. These puncture surface features 90 may be placed along and adjacent to the second edge 14 and extend between the third edge 16 and the fourth edge 18. This location may be referred to as the footer portion 130. In this embodiment, the first and second edges 12, 14 may be shorter in length that the third and fourth edges 16, 18. Further, the first plurality of puncture surface features 80 may have a different configuration than the second plurality of puncture surface features 90, and the various embodiments of the plurality of puncture surface features 80, 90 may include a combination of surface elements. The combination may be optimized for traction, friction, tactile sensitivity and flexibility to improve processing through a printer or scanner device, ease of handling the sheets by the user, and visual aesthetics. Further, the plurality of puncture surface features 80, 90 may be a zone of increased flexibility imparted by coating or embossing to improve printer processing. Printing processing issues may be improved to reduce the skewing of printed indicia during printing through a printer device and reduce the occurrence of having multiple sheets fed through the printer at once, leading to jam.

As such, known label sheet assemblies may have experienced difficulty being fed through printers thereby causing indicia to be applied “off-register” or out of alignment with the intended position along the indicia receiving portions of the labels 60. This off-registration may be due, in part, to the level of friction between a leading edge of the label sheet and the receiving area of the printer device.

In one embodiment, the plurality of puncture surface features 80, 90 are added to improve the way in which label sheet assemblies 10 are fed through printers to receive indicia on the labels 60. The first and second plurality of puncture surface features 80, 90 may be provided to improve the accuracy of indicia application while undergoing stresses caused by processing the label sheet assembly 10 though the printer. The first and second plurality of puncture surface features 80, 90 may have various orientations that improve frictional abutment with the printer. Additionally, the plurality of puncture surface features 80, 90 are flexible enough to allow the printer device to individually index the label sheet assemblies 10 as they are positioned in a stacked orientation relative to one another and being processed by the printer.

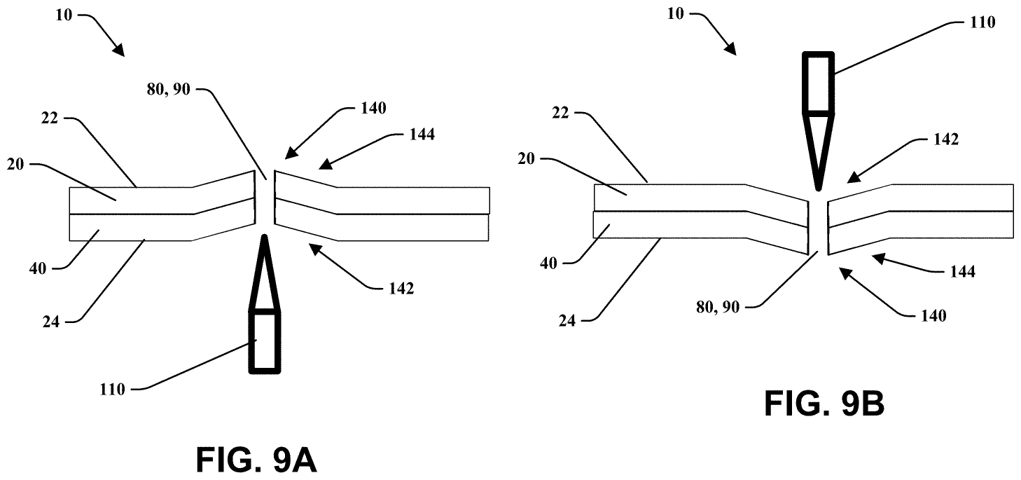

The plurality of puncture surface features 80, 90 may include a plurality of puncture holes formed into a pattern 100A, 100B. FIGS. 9A and 9B illustrate that the puncture holes may be formed with a puncture tool 110 that includes at least one elongated rigid member with a piercing edge configured to pierce through and withdraw from the facestock layer 20 and the liner layer 40 in a desired pattern. The puncture tool 110 may include a plurality of die pins having piercing edges, or just a single die pin edge configured to extend through and withdraw a plurality of times to form the particular pattern 100. The puncture holes include a perimeter that includes a surface feature effect 140 relative to the remaining top surface 22 of the facestock layer 20 or bottom surface 24 of the liner sheet layer 40. The surface feature effect 140 of the perimeter of the puncture holes 80, 90 may include a slightly concave shape 142 along one side, along with a slightly convex shape 144 along the opposite side. The surface feature effect 140 may be considered a textured edge along the header portion 120 or the feeder portion 130 of the label sheet assembly that improves printer feedability through a printer device to print indicia on the labels 60.

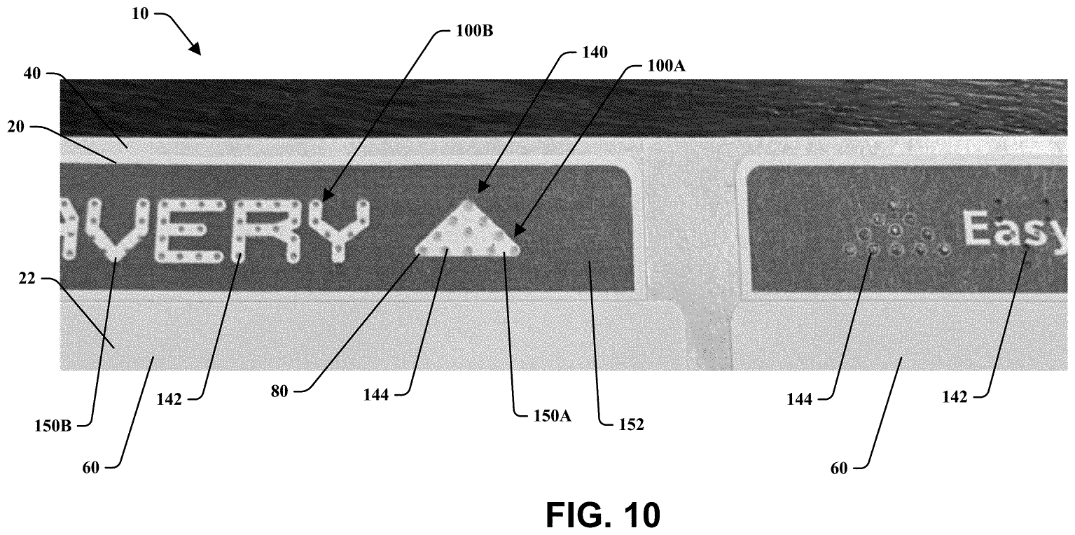

FIG. 10 is an illustration of an embodiment of the label sheet assembly 10 that includes a plurality of puncture surface features 80 along the header portion 120 within the matrix portion 70 of the facestock layer 20. The first row of labels 60 includes a matrix portion 70 having a plurality of puncture surface features 80 formed in a first pattern 100A (in the shape of a triangle or arrow) and a plurality of puncture surface features 80 formed in a second pattern 100B (in the shape of the font “AVERY”). Here, it was found desirable to form the first pattern 100A with puncture holes formed by the die pin 110 through the bottom side 24 (FIG. 9A) to form the slightly convex shape 144 along the top surface 22 for each of the plurality of puncture surface features 80 of the first pattern 100A. Also, the second pattern 100B is formed by puncture holes formed by the die pin 110 through the top side 22 (FIG. 9B) to form the slightly concave shape 142 along the top surface 22 for each of the plurality of puncture surface features 80 formed in the second pattern 100B.

Notably, in an embodiment, the first pattern 100A and the second pattern 100B may include a surrounding or outline pattern 150A, 150B having a color that is in registry with the plurality of puncture surface features 80 of the first pattern 100A or second pattern 100B. The outline pattern 150A, 150B may include a color or indicia that are generally contrasted with the remaining color or indicia along the remaining surface of the facestock layer 20 or liner layer 40 that is not a part of said pattern 100A, 100B. The resulting combination of the puncture surface features 80, along with the surrounding pattern 150A, 150B in registry, has been found to provide desirable visual and textural assistance to a user that allows the user to easily visualize the type of label sheet assembly 10 and an intended direction of printing processing through a printer device. The texture assists to increase friction with pick-up rollers on consumer printers or scanners that can sometimes have trouble properly processing label sheets and feeding them through the printer device while also receiving printed indicia on the labels 60. As can be further seen from FIG. 10, the first pattern 100A and second pattern 100B are provided along a portion of the header portion 120 in alignment with a second row of labels 60. Here, the patterns 100A, 100B do not include the outline patterns 150.

The puncture surface features 80, 90 of the instant application have been found to provide a benefit over the surface features of existing label sheet assemblies, as they do not require the additional step of adding a layer of material, and provide the benefit of reducing material and manufacturing costs while also having the ability to provide slightly convex and slightly concave features along a pattern or shape along either side of the label sheet assembly to assist with processing multiple label sheets through a printer device reducing “off-registration.”

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The features of each embodiment described and shown herein may be combined with the features of the other embodiments described herein. The claims as follows are intended to include all modifications and alterations insofar as they come within the scope of the claims or the equivalent thereof

What is claimed is:

1. A label sheet assembly comprising:
a facestock layer having first and second sides, the facestock layer including at least one cut line that defines at least one label and a matrix portion on the first side wherein the facestock layer is configured to receive indicia thereon;
an adhesive layer along the second side;
a liner sheet layer having top and bottom surfaces, the top surface attached to the adhesive layer along the facestock layer; and
at least one puncture surface feature along the matrix portion of the facestock layer, wherein the at least one puncture surface feature includes a puncture hole that forms a slightly concave shape along one side and a slightly convex shape along the opposite side, and wherein the at least one puncture surface feature provides a zone of tactile sensitivity along the label sheet assembly and is configured to reduce off-registration of printed indicia along the at least one label when processed through a printer device.

2. The label sheet assembly according to claim 1, further comprising a plurality of puncture surface features applied along a header portion of the first side of the facestock layer wherein the plurality of puncture surface features are formed into a first pattern.

3. The label sheet assembly according to claim 2, further comprising a plurality of puncture surface features applied along a header portion of the first side of the facestock layer wherein the plurality of puncture surface features are formed into a second pattern.

4. The label sheet assembly according to claim 2, further comprising a plurality of puncture surface features applied along a footer portion opposite from the header portion.

5. The label sheet assembly according to claim 2, wherein the plurality of puncture surface features that form the first pattern include an outline pattern having a color that is in registry with the plurality of puncture surface features of the first pattern.

6. The label sheet assembly according to claim 5, wherein the outline pattern includes a color or indicia that is generally contrasted with the remaining color or indicia along the surface of the facestock layer that is not in registry with said outline pattern.

7. The label sheet assembly according to claim 3, wherein the plurality of puncture surface features that form the second pattern include an outline pattern having a color that is in registry with the plurality of puncture surface features of the second pattern.

8. The label sheet assembly according to claim 7, wherein the outline pattern includes a color or indicia that is generally contrasted with the remaining color or indicia along the surface of the facestock layer that is not in registry with said outline pattern.

9. The label sheet assembly according to claim 3, wherein the plurality of puncture surface features that form the first pattern form a slightly concave shape along the top surface and the plurality of puncture surface features that form the second pattern form a form a slightly concave shape along the top surface.

10. The label sheet assembly according to claim 1, wherein the header portion and the footer portion include a color that is different from the at least one label of the facestock layer.

11. A label sheet assembly comprising:
a facestock layer having first and second sides, the facestock layer including at least one cut line that defines at least one label and a matrix portion on the first side wherein the facestock layer is configured to receive indicia thereon;
an adhesive layer along the second side;
a liner sheet layer having top and bottom surfaces, the top surface attached to the adhesive layer along the facestock layer; and
a plurality of puncture surface features along the matrix portion of the facestock layer, wherein the plurality of puncture surface features each include a puncture hole that forms a slightly concave shape along one side and a slightly convex shape along the opposite side, and wherein the plurality of puncture surface features provide a zone of tactile sensitivity along the label sheet assembly and is configured to reduce off-registration of printed indicia along the at least one label when processed through a printer device.

12. The label sheet assembly according to claim 11, wherein the plurality of puncture surface features are positioned along a header portion of the first side of the facestock layer wherein the plurality of puncture surface features are formed into a first pattern.

13. The label sheet assembly according to claim 12, wherein the plurality of puncture surface features are formed into a second pattern that is different from the first pattern and positioned along the header portion of the first side of the facestock layer.

14. The label sheet assembly according to claim 11, further comprising a plurality of puncture surface features applied along a footer portion opposite from the header portion.

15. The label sheet assembly according to claim 11, wherein the plurality of puncture surface features that form the first pattern include an outline pattern having a color that is in registry with the plurality of puncture surface features of the first pattern.

16. The label sheet assembly according to claim 15, wherein the outline pattern includes a color or indicia that is generally contrasted with the remaining color or indicia along the surface of the facestock layer that is not in registry with said outline pattern.

17. The label sheet assembly according to claim 13, wherein the plurality of puncture surface features that form the second pattern include an outline pattern having a color that is in registry with the plurality of puncture surface features of the second pattern.

18. The label sheet assembly according to claim 17, wherein the outline pattern includes a color or indicia that is generally contrasted with the remaining color or indicia along the surface of the facestock layer that is not in registry with said outline pattern.

19. The label sheet assembly according to claim 13, wherein the plurality of puncture surface features that form the first pattern form a slightly concave shape along the top surface and the plurality of puncture surface features that form the second pattern form a form a slightly concave shape along the top surface.

20. The label sheet assembly according to claim 11, wherein the header portion and the footer portion include a color that is different from the at least one label of the facestock layer.
